(19) United States
(12) Patent Application Publication
(10) Pub. No.: US 2010/0286897 A1
(43) Pub. Date: Nov. 11, 2010

(54) Method and Apparatus for Controlling Traffic Flows With Hazardous Goods Transport Vehicles Moving Through a Safety Critical Traffic Area in a Road Network, in Particular Through a Road Tunnel

(75) Inventors: Igor Dedic, Berlin (DE); Stefan Höpfel, Augsburg (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/679,342

(22) PCT Filed: Sep. 1, 2008
(86) PCT No.: PCT/EP2008/061496

§ 371 Date: Mar. 22, 2010

(30) Foreign Application Priority Data
Sep. 24, 2007 (DE) 10 2007 045 461.0

(51) Int. Cl. G08G 1/07

(52) U.S. Cl. 701/117

(57) ABSTRACT

A method and a device for controlling traffic flows with vehicles transporting hazardous goods, the vehicles moving through a security-critical traffic area of a road network, in particular through a road tunnel. When a vehicle approaches the traffic area it is established whether it is a vehicle transporting hazardous goods, and a traffic signal is output to the vehicle approaching the traffic area. In that a digital image is recorded of a vehicle approaching the traffic area, and in that the recorded image is digitally analyzed to recognize a feature which identifies a vehicle transporting hazardous goods, vehicles transporting hazardous goods may be recognized and controlled simply, reliably, and largely independently of vehicle equipment.

Method and apparatus for controlling traffic flows with hazardous-goods transport vehicles moving through a safety-critical traffic area in a road network, in particular through a road tunnel.

The invention relates to a method for controlling traffic flows with hazardous-goods transport vehicles moving through a safety-critical traffic area in a road network, in particular through a road tunnel, according to the precharacterizing clause of patent claim 1, and to an apparatus for control according to the precharacterizing clause of patent claim 12.

The conveyance of hazardous goods on the road involves a particular risk, in particular in safety-critical traffic areas, for example in tunnels, on bridges, in water conservation areas or in built-up areas. Accidents in which a hazardous-goods transport vehicle is involved may have disastrous consequences, depending on the nature of the hazardous goods—for example fire, explosion, development or release of toxic substances. However, one particular hazard occurs when vehicles are passing through safety-critical traffic areas, when an interaction of the transported hazardous goods would lead to undesirable reactions, for example the explosive reaction of oxygen gas with hydrogen gas.

U.S. Pat. No. 5,347,274 discloses a system for management of hazardous-goods transports, having mobile vehicle-side transmitter/receiver appliances, having a range of roadside transmitter/receiver stations, and having a data network for bidirectional communication with the vehicle appliances via the road stations. The vehicle appliance can be arranged on the dashboard, can be attached to the vehicle or directly to the hazardous-goods container, and contains information data relating to the hazardous goods being transported. Load monitoring sensors measure the state of the hazardous goods while they are being transported, and trigger an alarm when there is a threat of danger—for example as a result of increased pressure or temperature values. The alarm is signaled to the driver, and is signaled via the communication network to the transport company.

U.S. Pat. No. 6,729,540 B2 discloses a system for management of dynamic situations involving transport vehicles for waste. Each transport vehicle is equipped with a position-finding system, which determines the vehicle position and signals it to a control center, in order to make it possible to track the route of the vehicles in real time in the control center from a generator company, from where the waste is picked up, to a waste disposal facility. A transponder is fitted to each vehicle, with a vehicle identification which is read by a reader on the facility side as an access check to the disposal facility. The vehicle is provided with a labeling system, which contains data about the pick-up location and the nature of the waste, in the form of a barcode.

U.S. Pat. No. 6,754,580 B1 discloses a vehicle control system in which the road network is considered to be a data network. Vehicles involved must register with the system, and must identify themselves via a control identification. The vehicles transmit their destinations and, at regular intervals, their position and speed to a traffic information control center. The traffic information control center transmits route proposals in the opposite direction to the vehicles. In addition to an IP address for the data network, the control identification includes personal details relating to the user and information about the vehicle and load, for example a load of hazardous goods. Public vehicles, emergency-service vehicles, heavy goods vehicles and hazardous-goods transporters may request a route clearance or a green wave of roadside facilities, for example controllers for light signal installations. The traffic management also makes use of screens on which light signal installations, bridges with their clearance data and speed restrictions and environmental restrictions on the road network are displayed.

The known methods and apparatuses for controlling traffic flows with hazardous-goods transport vehicles suffer from the disadvantage that the vehicles which are transporting hazardous goods must be equipped with complex devices, such as transmitter/receiver appliances, load monitoring sensors, position-finding systems, transponders or the like.

The invention is therefore based on the object of providing a method and an apparatus of the type mentioned initially, with the aid of which it is possible to identify and control hazardous-goods transport vehicles easily, safely and largely independently of vehicle-side equipment.

The method part of the object is achieved by a method of this generic type having the characterizing features of patent claim 1. Since a digital image is recorded of a vehicle which is approaching the traffic area, and the recorded image is digitally evaluated in order to identify a feature which characterizes a hazardous-goods transport vehicle, it is possible to confirm without any special vehicle appliances whether the approaching vehicle is a hazardous-goods transport vehicle. By emitting a centrally triggered traffic signal to a vehicle which is approaching the traffic area, this vehicle can be influenced by a control action in order to prevent the occurrence of critical traffic situations, without having to take any special vehicle-side precautions—other than the presence of a characterizing feature.

In one advantageous refinement of the method according to the invention, a time series of digital images is recorded of a vehicle which is approaching the traffic area. The identification confidence can be increased by evaluating an image series. Furthermore, phenomena which vary over time, for example a change in the size of the characterizing feature, can be observed on the image series.

In one preferred embodiment of the method according to the invention, a detail of a recorded image which contains the feature is determined. The digital evaluation of only an image detail which has the feature of interest speeds up the evaluation process, since the identification software has to process less image data.

In one advantageous embodiment of the method according to the invention, the feature is formed by a display area, which is arranged on the hazardous-goods transport vehicle, for characters and/or images. A display area which is applied to a vehicle can be determined by its boundary or by its arrangement position on the vehicle as an image detail of interest, which is then evaluated in a further step in order to identify a hazardous-goods transport vehicle.

Preferably, the feature is defined by shape and/or size and/or arrangement position, and/or coloring and/or character content and/or image content of the display area. Evaluation algorithms which are known per se use one or more of these characteristics to identify the feature which characterizes a vehicle as a hazardous-goods transporter.

In one preferred refinement of the method according to the invention, the display area is in the form of a large label and/or orange-colored identification and/or registration for substances which are conveyed in the heated state. These registration features are defined in the “Annex for notification of the new version of Annexes A and B of the European Convention of Sep. 30, 1957 relating to the International conveyance of hazardous goods on roads”, ADR for short, and are a legal requirement for vehicle identification.

In a further advantageous refinement of the method according to the invention, the display area is in the form of an official motor-vehicle registration. The identification of the official license registration represents an additional identification feature which can be used to identify or re-identify a vehicle as a hazardous-goods transport vehicle. For example, the motor-vehicle registration of the fleet vehicles of hazardous-goods transport companies could be managed electronically, centrally, and could be linked to the information relating to the respectively transported hazardous goods.

In a further advantageous embodiment of the method according to the invention, a speed of an approaching vehicle is determined from a position of an optical axis of a video camera, which is recording the digital images, and from the rate of change of the size of the feature. The time period before the hazardous-goods transport vehicle will enter the safety-critical traffic area can be determined from the determined speed and location of the video detection. This can be used to calculate whether this situation could result in a hazardous vehicle passage within the traffic area, making it possible to carry out a control action, if necessary, in order to influence the approaching vehicle.

In a further preferred refinement of the method according to the invention, a digital image is recorded of a vehicle which is moving away from the traffic area, and the recorded image is digitally evaluated in order to identify a feature which characterizes a hazardous-goods transport vehicle. It is therefore possible to determine whether a hazardous-goods transport vehicle which has been identified on entering the safety-critical traffic area has safely departed from the traffic area again, or whether it is still in the traffic area.

In another advantageous refinement of the method according to the invention, a feature and/or a speed and/or a time of a hazardous-goods transport vehicle on entry into and/or on exiting from the safety-critical traffic area are/is transmitted to a control center (20), and the traffic signals are emitted, triggered centrally, in order to prevent hazardous-goods transport vehicles from passing within the safety-critical traffic area in a manner which endangers safety. The central correlation of the entry and exit data relating to hazardous-goods transport vehicles makes it possible to determine and trigger any control actions which may be necessary, that is to say the emission of a traffic signal.

In another preferred embodiment of the method according to the invention, the traffic signal indicates a refusal or a clearance for entry into the traffic area and/or a speed limit and/or a direction for a lane change. These signals preferably relate only to drivers of hazardous-goods transport vehicles, in order not to impede the rest of the traffic flow. In order to avoid a safety-critical passage of two or more hazardous-goods transport vehicles within the traffic area, a refusal signal can be passed to an approaching vehicle, which denies entry to the traffic area to a driver of this hazardous-goods transport vehicle until he receives a clearance signal—after another hazardous-goods transport vehicle which is already moving in the traffic area has left it. For some critical hazardous goods, it may be sufficient to reduce the maximum permissible speed in the traffic area by means of an appropriate signal, or else—for example when there are a plurality of lanes in each direction of travel—to use a direction signal to allow the hazardous-goods transport vehicles to use only the respective right-hand lane.

The apparatus part of the object is achieved by an apparatus of this generic type having the characterizing features of patent claim 12. A device for confirming whether a vehicle which is approaching the traffic area is a hazardous-goods transport vehicle is in the form of a video camera for recording a digital image. A device for digital evaluation of the recorded images is connected to the video camera and to a control center, and is designed such that it is possible to identify a feature which defines a hazardous-goods transport vehicle and is imaged on a recorded image. The control center is designed to receive a hazardous-goods transport signal from the confirmation device, and to trigger switching commands to the signal transmitter in order to emit a traffic signal to a vehicle which is approaching the traffic area.

Further advantages of the invention will become evident from an exemplary embodiment, which will be explained in more detail below with reference to the drawings, in which, illustrated schematically:

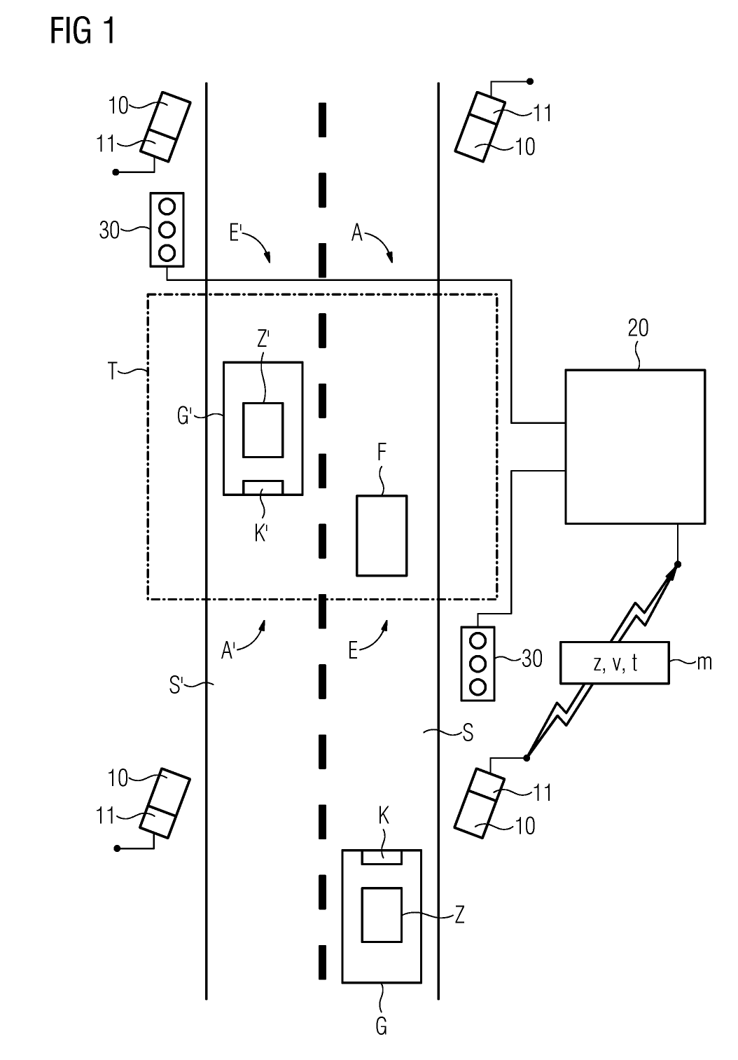

FIG. 1 shows a control apparatus according to the invention,

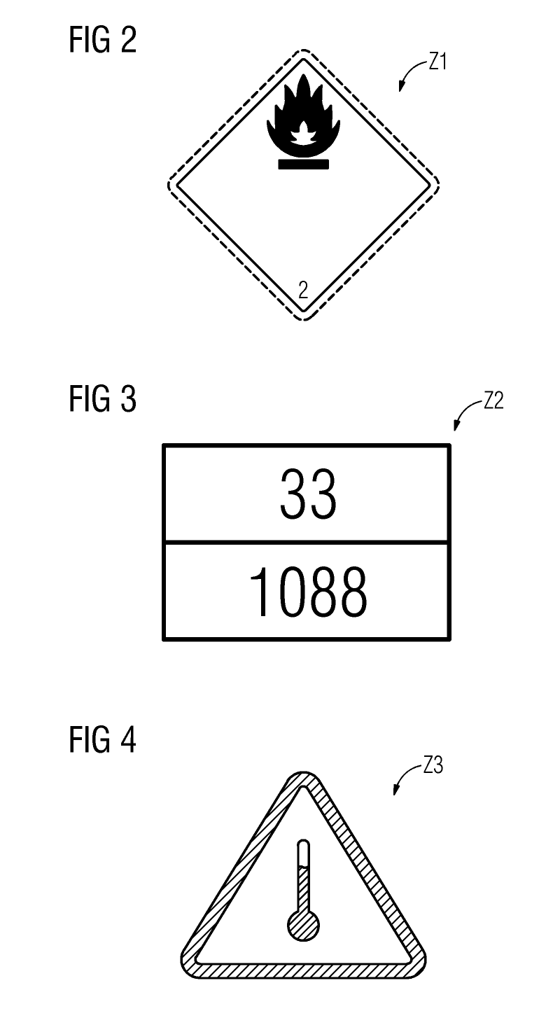

FIG. 2 shows a display area in the form of a large label,

FIG. 3 shows a display area in the form of an orange-colored identification,

FIG. 4 shows a display area which is in the form of a registration for substances which are conveyed in the heated state.

In FIG. 1, a road carriageway S and an opposite carriageway S′ passes through a tunnel T which represents a safety-critical traffic area because of its rigid carriageway boundaries, the restricted visibility and ventilation conditions in it, and the restricted stopping and escape capabilities. In order to avoid risky passages of vehicles G and G′, respectively, which are transporting hazardous goods within the tunnel T, signal transmitters 30 are arranged at the entrances E and E′, respectively, of the tunnel, and can be used to emit traffic signals to drivers of approaching hazardous-goods transport vehicles G and G′, respectively.

In the illustrated exemplary embodiment, the signal transmitters 30 emit refusal or clearance signals, in order to refuse or clear access to the entrance to the tunnel T for a hazardous-goods transport vehicle G or G′. Alternatively or additionally, traffic signals can also be provided for speed limiting or for lane changing.

According to the invention, a video camera 10 is in each case arranged on the roadside at a sufficiently long distance before the signal transmitter 30. The video cameras record digital images of vehicles which are approaching the tunnel T, and these images are digitally evaluated by means of a device 11 for identification of a feature which characterizes a hazardous-goods transport vehicle G or G′. In this case, in particular, the vehicle identifications Z which are internationally required in accordance with ADR for the conveyance of hazardous goods on the road, which are shown on display areas and are illustrated in FIG. 2 to FIG. 4, are used as a feature. In addition, the official motor-vehicle registrations K, which are likewise shown on display areas, can also be used to identify or re-identify a hazardous-goods transport vehicle G or G′.

Optical pattern recognition methods are used for this purpose, using which it is possible to identify the character content and possibly the image content of the display area, and from this the feature which characterizes the transported hazardous goods, from the shape, size, arrangement position and color. The numbers and alignments of the video cameras are arranged with their optical axes such that all the features Z and K of an approaching vehicle G are identified, and the speed v of the approaching vehicle G is determined from the rate of change of the size of a feature. When a hazardous-goods transport vehicle G is identified as such, the evaluation device 11 transmits a hazardous-goods transport signal m, which has data relating to the feature z or k, relating to the speed v and to the measurement time t, to a control center 20 for the tunnel T. The control center 20 also receives signals m such as these from video cameras 10 and evaluation devices 11 which are arranged at the exits A and A′, respectively, of the tunnel T, in order to confirm there whether an identified hazardous-goods transport vehicle G or G′ has left the tunnel T again.

The received signals m allow the control center 20 to use data processing means, which are not illustrated, to decide whether there is a threat of a risky vehicle passage, and to send appropriate switching commands to the signal transmitters 30. By way of example, the evaluation devices 11 are for this purpose connected to the control center 20 via a wireless communication link, and the signal transmitters 30 are connected to the control center 20 via a data line, for example.

The approach of a vehicle F which does not have a feature characterizing a hazardous-goods transport vehicle is identified as such by the evaluation device 11; no hazardous-goods transport signal m is sent to the control center 20. However, the control center 20 will have registered the entry of a hazardous-goods transport vehicle G′ on the opposite carriageway S′, but not yet its exit. The control center 20 therefore has the information that a hazardous-goods transport vehicle G′ is moving on the opposite carriageway S′ in the tunnel T, which vehicle G′ is conveying hazardous goods corresponding to the registration Z′ and, if appropriate, has the official motor-vehicle registration K′. When a signal is now passed to the control center 20 at the time t that a hazardous-goods transport vehicle G on the carriageway S and having a hazardous-goods registration Z is approaching the entrance E to the tunnel T at a speed v, the hazardous goods which correspond to the registrations K and K′ are compared for their potential risk in the event of a collision. In the event of an excessively high risk, a switching command for a refusal signal is triggered in the control center 20, and is emitted via the signal transmitter 30 to the driver of the hazardous-goods transport vehicle G. The hazardous-goods transport vehicle G can then stop in a waiting lane before the entrance E to the tunnel, until the signal transmitter 30 emits a clearance signal, once the hazardous-goods transport vehicle G′ traveling in the opposite direction has left the tunnel T through the exit A′.

A risk comparison list of hazardous goods is stored in the control center 20 and is used as the decision basis for the control action. A classification of substances including solvents and mixtures according to ADR with a high hazard potential is:

1. Explosives and items with explosive

### 2. Gases

3. Combustible liquid substances
4.1 Combustible solid substances, self-decomposing substances and desensitized explosives
4.2 Self-igniting substances
4.3 Substances which develop combustible gases in contact with water
5.1 Substances with an igniting (oxidizing) effect
5.2 Organic peroxides
6.1 Toxic substances
6.2 Hazardous infection substances
7. Radioactive substances
8. Corrosive substances
9. Various hazardous substances and items

As an example of display areas with hazardous-goods registrations Z which are arranged on hazardous-goods transport vehicles, FIG. 2 shows a large label 21, a so-called placard, for combustible gases. This large label Z1 is formed by a diagonal square (rhomboid) with a side length of at least 250 mm, which is provided with a black boundary and has a black flame symbol on a red background, as well as the number “2” in the lower corner.

An orange-colored identification Z2 as shown in FIG. 3 has two rectangular, reflective, vertically fitted orange-colored panels with the side lengths 400 mm×300 mm, and with an edge with a width of 15 mm. There is a number in the upper part, in order to identify the risk, for example “33” for an easily combustible liquid substance (flashpoint below 23° C.). In the lower part, there is a four-digit UN number, for example “1088”, in order to identify substances or items in accordance with UN model rules.

A registration Z3 for substances which are conveyed in the heated state is in the form of a triangle with a side length of at least 250 mm, which must be displayed red in the shaded area from FIG. 4. This must be applied to both sides of the vehicle, and to the rear, in accordance with a special rule, for example for tankers.

On the basis of the configuration of the hazardous-goods registrations Z1 to Z3, as defined in ADR, these registrations can be reliably identified by appropriate identification algorithms in the course of video detection.

1-12. (canceled)

13. A method of controlling traffic flows with hazardous-goods transport vehicles moving through a safety-critical traffic area in a road network, which comprises:
determining whether or not a vehicle approaching the safety-critical traffic area is a hazardous-goods transport vehicle, wherein a digital image is recorded of the vehicle approaching the traffic area, and the recorded image is digitally evaluated in order to identify a feature characterizing a hazardous-goods transport vehicle;
transmitting to a control center a feature, a speed, and a time of the hazardous-goods transport vehicle on entry into and on exiting from the safety-critical traffic area; are
emitting centrally triggered traffic signals to the hazardous-goods transport vehicle in order to prevent the hazardous-goods transport vehicle from passing within the safety-critical traffic area in a safety-endangering manner.

14. The method according to claim 13, wherein the safety-critical traffic area is a road tunnel.

15. The method according to claim 13, which comprises recording a time series of digital images of the vehicle approaching the traffic area.

16. The method according to claim 13, which comprises determining a detail of a recorded image containing the feature.

17. The method according to claim 13, wherein the feature characterizing a hazardous-goods transport vehicle is formed by a display area, which is arranged on the hazardous-goods transport vehicle, for characters and/or images.

18. The method according to claim 17, wherein the feature is defined by at least one of a shape, a size, an arrangement position, a coloring, a character content, and an image content of the display area.

20. The method according to claim 17, wherein the display area is in at least one of the following forms: a large label, a orange-colored identification, and an identification for substances that are conveyed in a heated state.

20. The method according to claim 17, wherein the display area carries an official motor-vehicle registration identification.

21. The method according to claim 13, which comprises determining a speed of an approaching vehicle from a position of an optical axis of a video camera recording the digital images, and from a rate of change of a size of the feature.

22. The method according to claim 13, which comprises recording a digital image of a vehicle moving away from the traffic area, and digitally evaluating the recorded image in order to identify a feature characterizing a hazardous-goods transport vehicle.

23. The method according to claim 13, wherein the traffic signals indicate a refusal or a clearance for entry into the traffic area, a directed speed limit, and/or a direction for a lane change.

24. An apparatus for controlling traffic flows with hazardous-goods transport vehicles moving through a safety-critical traffic area in a road network, the apparatus comprising:
a signal transmitter for emitting a traffic signal to a hazardous-goods transport vehicle approaching the safety-critical traffic area;
a video camera disposed at an entrance to the safety-critical traffic area for recording a digital image of the vehicle approaching the safety-critical traffic area and a video camera disposed at an exit from the safety-critical traffic area;
an evaluation device connected to each said video camera and configured for digital evaluation of the digital image for identifying a feature defining a hazardous-goods transport vehicle and, if applicable, for generating a hazardous-goods transport message containing a feature and a speed and a time of a hazardous-goods transport vehicle; and
a control center connected to said evaluation device for receiving the hazardous-goods transport message and for triggering switching commands to said signal transmitter, said control center being configured to trigger traffic signals in order to avoid safety-critical passages of hazardous-goods transport vehicles within the safety-critical traffic area.

25. The apparatus according to claim 24, wherein the safety-critical traffic area in the road network is a road tunnel.
